(19) United States
(12) Patent Application Publication
(10) Pub. No.: US 2024/0012538 A1
(43) Pub. Date: Jan. 11, 2024

(54) MULTI-PROCESS INTERFACE CONTROLLER (2-D)

(71) Applicant: WGAMES INC., County of Newcastle, DE (US)

(72) Inventor: Daniel KAJOUIE, Toronto (CA)

(21) Appl. No.: 18/371,695

(22) Filed: Sep. 22, 2023

Related U.S. Application Data
(63) Continuation of application No. 16/973,242, filed on Dec. 8, 2020, now abandoned.
(60) Provisional application No. 62/683,854, filed on Jun. 12, 2018.

(51) Int. Cl. G06F 3/0482; G06F 3/0485; G06F 3/0488; G06F 3/147; G06T 11/20

(52) U.S. Cl. CPC G06F 3/0482; G06F 3/0485; G06F 3/0488; G06F 3/147; G06T 11/206; G06F 16/2282

(57) ABSTRACT

Improved electronic interface controllers for data processors, including particularly interface controllers configured to enable users of a touchscreen or other interactive devices to rapidly and efficiently identify and selectively invoke one or more data processing applications controlled by the interactive device. Data processes can be displayed in two-dimensional arrays in such way that in either or both dimensions choices of applications can scroll indefinitely in any direction, with choices looping back on themselves so that processes can be rapidly identified and selected.

### CROSS-REFERENCE TO RELATED APPLICATION

This application is a continuation of U.S. patent application Ser. No. 16/973,242, filed Dec. 8, 2020, which is a 371 continuation of PCT/CA2019/000090, filed Jun. 12, 2019, which claims priority to U.S. Provisional Patent Application Ser. No. 62/683,854, filed 12 Jun. 2018, the entire contents of which are incorporated herein by this reference.

### FIELD OF THE INVENTION

The present disclosure relates to improved electronic interface controllers for data processors, and more particularly to interface controllers configured to enable a user of a touchscreen or other interactive device to identify and selectively invoke one or more data processing applications controlled by the interactive device.

### BACKGROUND OF THE INVENTION

Users of systems for enabling data processors such as smart phones, desktop computers, and other personal digital assistants sometimes wish to access large number of choices of data processes, such as games, that are of one or more types or classes, and to do so rapidly and efficiently. Current systems are open to improvements, as they are too often slow and inefficient.

### SUMMARY OF THE INVENTION

In various aspects, the present disclosure provides devices, systems, devices, persistently-stored, machine-interpretable programming and/or other data products for enabling rapid, secure, and efficient access by users of network communication devices and controllers to arbitrary numbers of various types and categories of smart phone, computer, and other types of data processing applications and programs, including games and a wide variety of other products.

The invention provides improved electronic interface controllers for data processors, including particularly interface controllers configured to enable users of a touchscreen or other interactive devices to rapidly and efficiently identify and selectively invoke one or more data processing applications controlled by the interactive device. Data processes can be displayed in two-dimensional arrays in such way that in either or both dimensions choices of applications can scroll indefinitely in any direction, with choices looping back on themselves so that processes can be rapidly identified and selected.

For example, in one aspect the invention provides a multi-process interface controller, comprising at least one data processor; at least one touchscreen input/output device; and at least one network communication system; wherein the at least one data processor is configured to: in accordance with command signals received from the at least one input device and logical rules associated with a multi-process access control application of the multi-process interface controller, generate a list processes request command data set; using the at least one network communication system, route the list processes request command data set to a multi-process host system; receive from the same or another multi-process host system, via the same or another network communication system and in response to the list processes request command data set, an available process list data set comprising data representing a listing of games or other processes; in accordance with logical rules associated with the same or another control application, generate display command signals useful for generating and displaying a graphical representation of at least a portion of a two-dimensional table or matrix of a plurality of identifiers associated with at least a portion of data processes associated with identifiers comprised by the available process list data set; in response to a scroll navigation command signal received from a same or other input device, generate display command signals useful for generating and displaying a graphical representation of at least a different portion of the two-dimensional table or matrix, comprising identifiers associated at least party with a different portion of data processes associated with identifiers comprised by the available process list data set, the at least partly different portion of data processes corresponding to data processes associated with different values according to at least a first of the two dimensions; if the display signal command generated in response to the scroll navigation command includes at least one of a minimum or a maximum value associated with least the first of the two dimensions, including in the identifiers associated with the different portion of data processes at least one identifier associated with a maximum or minimum value, respectively, of the first dimension; in response to a second navigation command signal received from a same or other input device, generate display command signals useful for generating and displaying a graphical representation of at least another different portion of the two-dimensional table or matrix, comprising identifiers associated at least party another different portion of data processes associated with identifiers comprised by the available process list data set, the at least partly different portion of data processes corresponding to data processes associated with different values according to at least a second of the two dimensions; and if the second display signal command generated in response to the scroll navigation command includes at least one of a minimum or a maximum value associated with least the second of the two dimensions, including in the identifiers associated with the other different portion of data processes at least one identifier associated with a maximum or minimum value, respectively, of the second dimension.

In the same and other embodiments, the invention provides such controllers, wherein the at least one data processor is configured to, in response to a command signal received from the same or another input device, initiate a data process identified by the command signal.

In same and further embodiments, the invention provides such controllers, wherein the at least one data processor is configured to generate at least one secondary image display data set comprising references to a plurality of data processes associated with at least one row and at least one column adjacent to a displayed portion of a two-dimensional table of data processes, and store the at least one secondary image display data set in cache memory associated with the at least one display.

In further aspects and embodiments, the invention provides persistent machine-interpretable media comprising data representing instructions for causing at least one processor of a multi-process interface controller to perform such processes.

The invention further provides corresponding processes.

### BRIEF DESCRIPTION OF THE DRAWINGS

Various aspects and embodiments of the invention are illustrated in the accompanying drawings, which are meant to be exemplary and not limiting, and in which like references are intended to refer to like or corresponding parts.

FIGS. 1-3 are schematic diagrams showing embodiments of and aspects of multi-process interface controllers in accordance with the invention.

FIG. 4 is a schematic diagram illustrating an example of inter-device communication processes in accordance with embodiments of some aspects of the invention.

FIGS. 5-8 are schematic diagrams showing concepts pertinent to further aspects of multi-process interface controllers in accordance the invention.

### DESCRIPTION OF EMBODIMENTS

In various aspects and embodiments, the invention provides improved electronic interface controllers for data processors, including particularly interface controllers configured to enable a user of a touchscreen or other interactive device to identify and selectively invoke one or more data processing applications controlled by the interactive device. The invention also provides related processes and programming products.

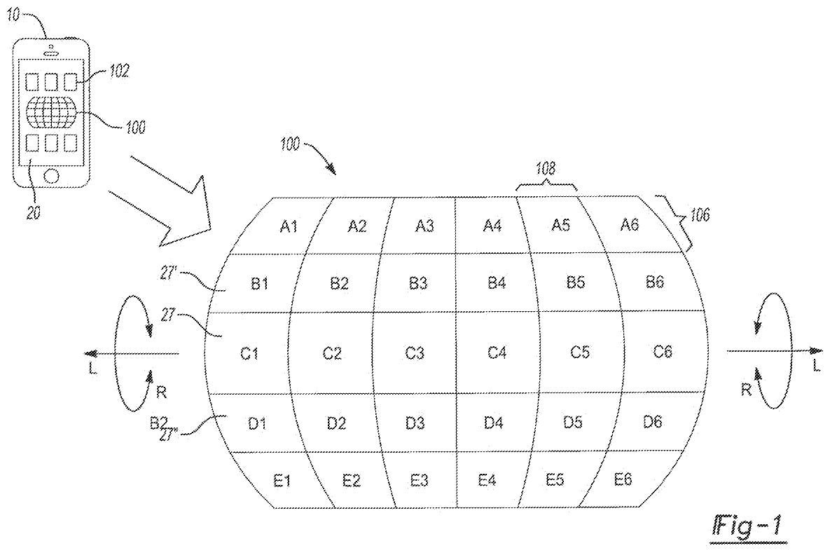

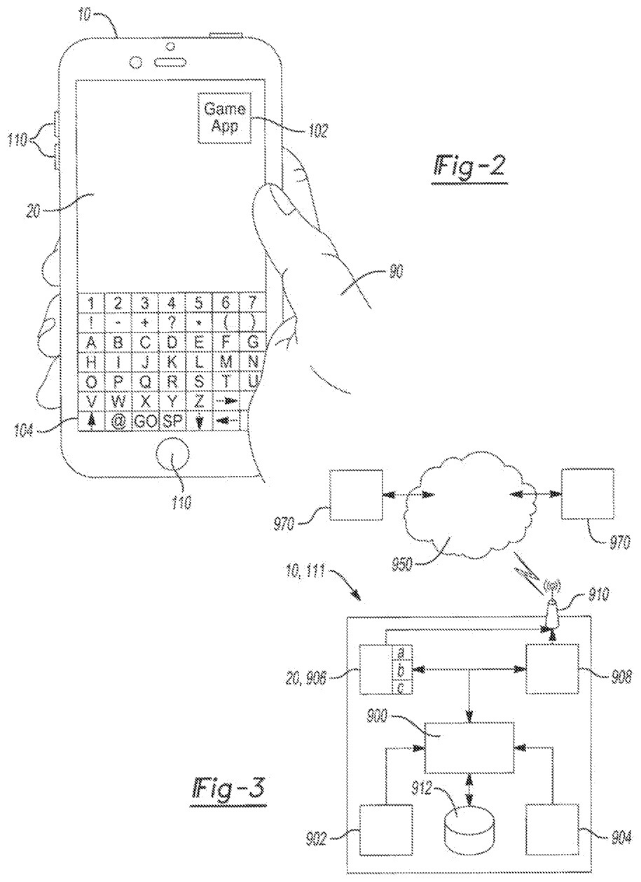

FIGS. 1 to 3 are schematic diagrams showing embodiments of aspects of a multi-process interface controller 10, 111 in accordance with the invention. In the embodiment shown, a multi-process interface controller 10 comprises a wireless or other network communication device 111 configured to enable a user 90 of a touchscreen 20 or other interactive device 906 to identify and selectively invoke one or more data processes (games) in accordance with the disclosure. In the embodiment shown, the controller 10 includes at least one or more data processors 900, one or more touchscreens 20 and/or other graphical displays and input devices 906, physical keyboard(s) and/or virtual keyboard application(s) or drivers 904, and one or more wireless or wireline communication systems 908 for communicating electronic data signals via one or more networks 950 such as the internet and/or public switched telephone network (PSTN).

As will be understood by those skilled in the relevant arts, once they have been made familiar with this disclosure, controllers 10 in accordance with the invention can be implemented using a very wide variety of devices, including for example general- or special purpose data processing systems such as smart phones, laptop and/or tablet computers or other personal digital assistants, desktop of other stationary processing systems, etc. In addition to the (sub)systems described above, such controllers can further comprise one or more data memories 912 and any number of programming memories or structures 902, comprising machine-interpretable instructions configured for execution by processor(s) 900 in order to implement operating systems and general or special purpose executable programming applications, such as applications configured to initiate and control processes such as games executed by the processor(s) 900 and/or, via communication system(s) 908, and network 950, by systems or devices 970 remote from the controller 10, 111.

Memory(ies) 912 can comprise any media suitable for enabling access by processor(s) 900 to data temporarily or persistently stored therein, including for example one or more of any or all of registers, buffers, caches, random-access memories (RAMs), read-only memories or firmware, flash drives, disk drives, etc., including registers, buffers, caches, RAMs and/or ROMs that may be physically and/or virtually separated for speed and efficiency in processing of operations described herein.

Such configurations can, for example, enable a user 90 of a device 10, 111 to access and initiate or otherwise invoke one or more of any number of data processes such as online games or other applications by using a specialized (e.g., gaming) app or general-purpose network browser to navigate via one or more networks 950 to a gaming server or other online program host site 970, and thereafter selecting an ‘access games’ item such as a graphical icon 102 on a touchscreen 20.

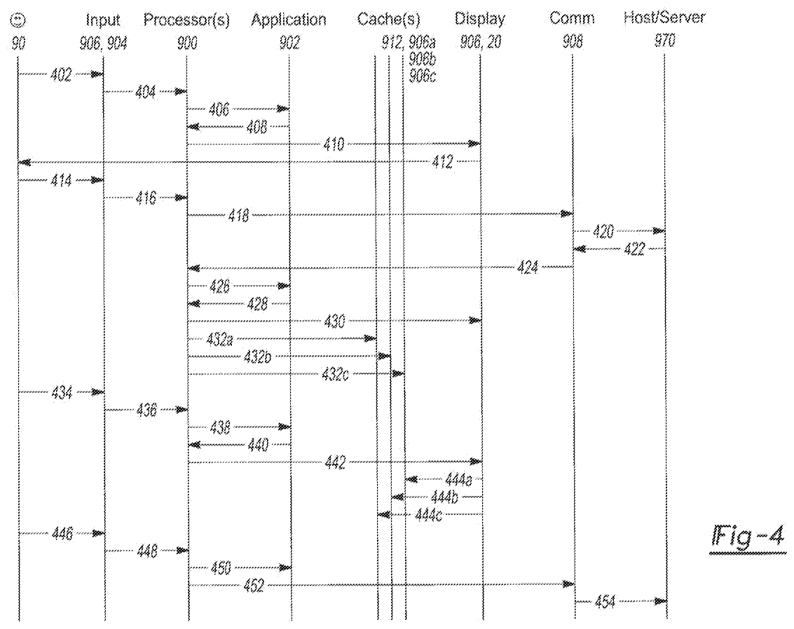

For example, as shown at 402, 404, 406 in FIG. 4, a user 90 of such a device 10, 111 can use either or both of a physical or virtual keyboard 104, 904 and an interactive application icon 102 and touchscreen 20, 906, to interact with processor(s) 900 in order to generate a set of command signals to invoke a gaming application stored in memory 902. At 408, invocation of a gaming or other application 102 can for example cause the application to 102 to cause processor(s) 900 to generate a ‘list games’ or other ‘list processes’ request, which can for example include signals representing at least the following data items:
<gaming server address><requesting user identifier ><game list request flag>
   where:
<gaming server address>=network resource identifier associated with a gaming or other application host or server 970 associated with the application 102, 902;
<requesting user identifier>=network resource or other identifiers associated with either or both of user 90 and device 10, 111; and
<game list request flag>=flag or other data set indicating a request for routing of a list of games or other processes available to the user, e.g., based on a users prior registration or subscription.

At 410-416, the processor(s) 900 can optionally request confirmation from the user 90 that he/she wishes the list games request be routed to the host or server 970 by routing, at 410, a confirmation request signal set to the display 20, 906; whereupon at 414 the user 90 can generate a confirmation data set by interacting with input device(s) 904, 906 and at 416 causing the confirmation data set to be returned to the processor(s) 900.

Processor(s) 900 can cause the (optionally confirmed) list games request to be routed to the desired server 970 by, at 418, routing the list games request data set to communication device(s) 908, which at 420 can format the data in accordance with a desired network communications protocol and route it to the intended host or server 970.

On receipt of signals representing the ‘list games’ or other list request data set, at 422 the gaming server 970 can return an available process list data set representing a listing of games or other processes. The listing can include an arbitrarily large number of gaming or other processing choices, depending for example upon authorizations granted by the server 970 to a user 90 associated with the requesting user identifier provided in the list request data set.

Ergo the game or other process list data set returned at 422 can for example include data representing at least:
<user device address><gaming server identifier><process listing>
   where:
<user device address>=network resource identifier(s) associated with either or both of the requested user 90 and/or a controller 10, 111 associated with the user 90 or the received list request data set;
<gaming server identifier>=network resource or other identifier(s) associated with the gaming or other application which generated the process listing; and
<process listing>=a data string comprising a plurality of identifier(s) associated games or other processes responsive to the listing request that the requesting user is authorized to access, or which the server 970 wishes to invite the user 90 to consider acquire authorization access.

In generating the available process (or game) list data set at 422, the gaming server 970 can work in accordance with any desired or otherwise suitable process(es). For example, the server 970 can consult tables of subscribed users to determine which games or processes a requesting user 90 is authorized to access, in accordance with any of a wide variety of known table look-up procedures.

At 424, the available process data list generated by the responding server 970 is received by the network communication system(s) 908 of the controller, is reformatted if/as required for use by the processor(s) 900, and is routed to the processor(s) for further handling.

Optionally, and in alternative embodiments, the process 402-424 of acquiring an available process listing can be replaced, in whole or part, through the generation by user 90 of commands suitable for causing processor(s) 900 to initiate a general-purpose network browser session, and using input device(s) 904, 906 to navigate to a gaming server 970 or an online gaming site operated by a server 970, and thereafter selecting an ‘access games’ item such as a graphical icon on a touchscreen, with processing proceeding generally as described above from 418-424.

On receipt of a game listing or other available process data set, either the user 90's gaming or other process app 902 or the gaming server 970 that provided the listing, or both, can generate a tabular interface that is limitlessly scrollable in either or both of two dimensions in order to provide an interactive listing of the games. As shown in FIGS. 1 and 5-8, for example, such table interface 100 can comprise a two-dimensional graphical representation 100 of a virtual wheel, toroid, or cylinder configured to enable the user 90 to scroll (1) virtually in the “R” sense (“up” and “down”) about an axis “L-L” as shown in the Figures, and (2) virtually in the “L” sense (“left” and “right”) along the L-L axis; and to loop back to a beginning when unique options in a chosen direction have been exhausted.

Among other advantages, such two-dimensional displays, which virtually loop around onto themselves, provide means for rapid, efficient, and convenient review by a user 90 of an unlimited number of data processing options; and easy initiation of desired processes once identified.

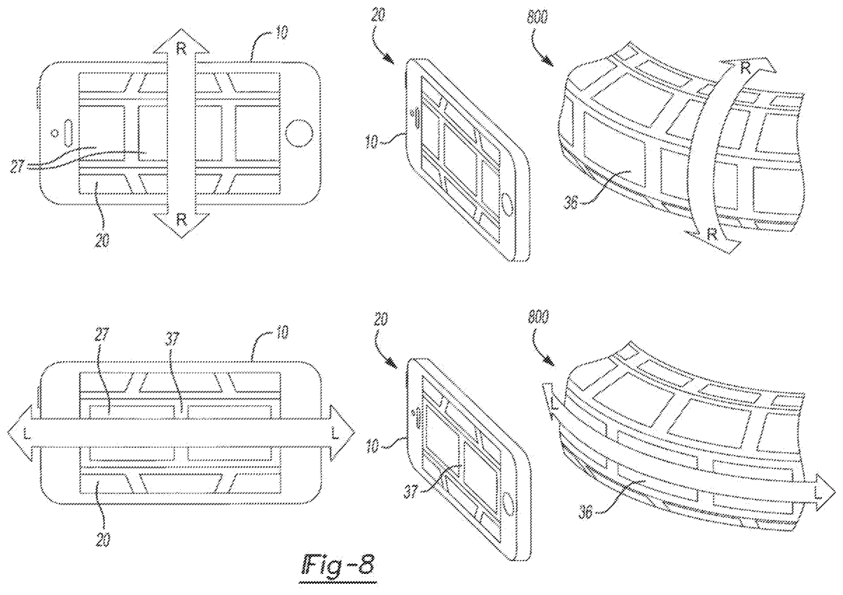

For example, such a virtual wheel or cylinder 100 can include an arbitrary number of rows 106 A1, A2, A3 . . . A(n), and an arbitrary number of columns (or virtual wheel or toroid slices) 108 A(i), B(i), C(i), . . . etc. An icon or other graphical device assigned to each unique row 106/column 108 position can be assigned to a separate game or process. Moreover, game or process choices A1, B1, etc., can be sorted by columns or rows into types of games, producers, favorites, etc., or other categories. For example, as shown in FIG. 8, a virtual mapping 100 of games can be sorted into sections 100A, 100B, 100C, etc., on the basis of game type, user preferences, producers, etc., through the use of suitably-configured data records.

Thus multiple levels of classification or type sorting can be provided, and unlimited numbers of choices of games or other options can be offered and conveniently, rapidly, and efficiently reviewed and selected.

To generate and display one or more portions of such looping tables, at 426 processor(s) 900 can process and optionally store in memory(ies) 912 some or all of the available process listing data set received at 424 in accordance with logic associated with the application 902. As a first step, the processor(s) 900 can apply processing rules associated with application 902 with the type of table to be presented, e.g., ring, cylinder, toroid, etc., in order to assign to each process option or choice a unique position in a two-dimensional table, a suitable subset designated for initial presentation, and a suitably configured table display data set can be generated.

For example, each of the games or other processes identified in the listing can be assigned a unique place X,N in a virtual table 100 (i.e., a two-dimensional matrix or data array), with the X value corresponding to a row A, 8, C., etc., as shown, and the N value corresponding to a column location 1, 2, 3, etc. Through the use of 2-dimensional or 3-dimensional image projection and 2-dimensional mapping techniques, a table mapping data set corresponding to some or all of a virtual table 100 can then be displayed by the users device 10 in the form of section of a wheel, toroid or cylinder comprising a plurality of interactive items A1, A2, A3 . . . 81, 82, 83, etc.

Alternatively, such a table mapping data set can be wholly or partially generated by a host 970, and routed to a requesting device 10, 111 together with or separately from the available process data set routed at 424.

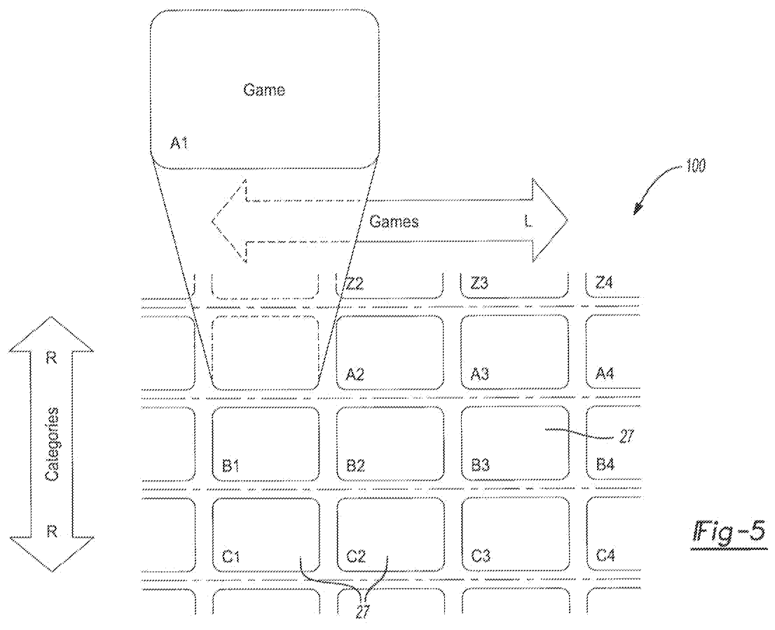

Further details can be appreciated through consideration of FIGS. 5-8. As shown in FIG. 5, at 426 in FIG. 4 an application 902 has been provided with a full or partial available process data set comprising data identifying a plurality of games or other processes available to a user 90. Data identifying an individual process within such a listing can for example comprise some or all of the following, and in various embodiments can include data representing further information:
<unique process ID><process address><class of application><subclass of application>
   where:
<unique process ID>=unique name associated with, or reference to, an available process
<process reference>=network or device address pointing to application or executable code or resource associated with the unique process ID
<class of application>=broad type or genus of application, for example, business application, game, informational resources
<subclass of application>=specific type, or species, of process, such as word processor, spreadsheet, etc., for business applications; virtual slot, social game, solitaire, etc., for games; travel, shopping, encyclopedia for informational resources.

At 426-428, the application 902 can control processor(s) 900 in generating a two-dimensional matrix which can be conceptually illustrated, and graphically represented, by a process grid, as shown in FIG. 5. Such a matrix can for example comprise a plurality of records of the form:
<Rowₓ><Column₁><process reference>
   where:
<Rowₓ>=unique row identifier, e.g., A, B, C . . .
<Columnᵢ>=unique column identifier, e.g., 1, 2, 3 . . .
<process reference>=network or device address pointing to application or executable code or resource associated with a unique process ID

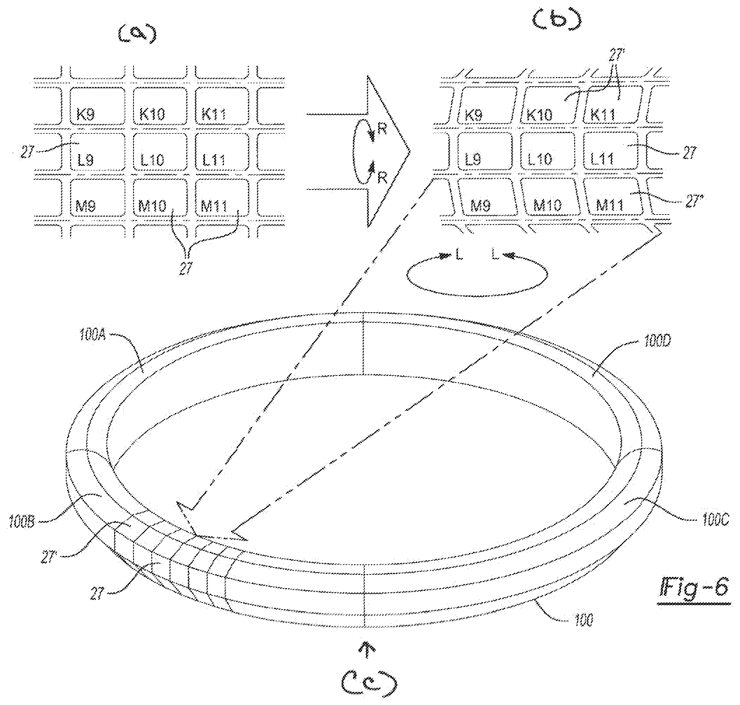

In embodiments in which one or more types or classes, and optionally one or more further sub types or sub classes are associated with the unique process IDs, processes can be sorted for display by assigning row and column numbers in ranges such as rows A-D, E-G, H-BB, etc.; and/or columns 1-3, 4-10, 11-12, as shown for example at 100A, 1008, 100C, 100D in FIG. 6.

With unique row and column numbers assigned to each process reference, and with process sorted into ranges of rows and columns as desired, processor(s) 900 (still at 428 in FIG. 4) can apply logic associated with the application 902 to determine an initial portion of the table, matrix, or array to be displayed, and can apply one or more geometric mapping processes to assign to such initial table portions two dimensional locations for on a display screen 20, 906 for display of the portions on such display(s).

For example, with reference to FIG. 5, processor(s) 900 can first assign an R,L location for placement of images or other graphical elements 27 (A1, A2, 81, 82 . . . ) associated with individual processes in a 2-dimensional mapping of the table portion to be displayed. In accordance with the logic associated with application 902, individual images such positions and images can, as shown in FIGS. 1, 6(a) and 6(b), be further mapped so as to present a three-dimensional appearance when displayed. For example, in a toroidal or cylindrical image mapping process, individual image data sets can be mapped to present distortions 27, 27′, 27″ etc. in accordance with their current places in the display. It will appreciated that a wide variety of suitable mapping and three-dimensional (3D) to two-dimensional (20) projection techniques are known, and doubtless others will be developed hereafter.

For example, as shown in FIG. 6, a gaming app can map a section of a toroid 100 so that a selection of a surface of the toroid is displayed by a user's device 10 in two-dimensional form, as either a two-dimensional (“flat”, FIG. 6A) or 3-dimensional perspective view (FIGS. 1, 68) of a three-dimensional object.

Still at 428 in FIG. 4, processor(s) 900 can apply logic associated with the application 902 to generate an initial image display data set. Such an initial imaged display data set can, for example, include at least:

<Row₁><Column₁><image₁><position₁><projection₁>
<Row₂><Column₂><image₂><position₂><projection₂>
<Row₃><Column₃><image₃><position₃><projection₃>
<Rowₙ><Columnₙ><imageₙ><positionₙ><projectionₙ>

where:
<Rowₓ>, <Columnᵢ>=unique row and column identifier associated with each process reference to be displayed
<imageᵢ>=image reference or image data associated with the i^{l}ₕ process reference. Can include html or other executable code(s) suitable for initiating the associated process, where for example interactive items are to be displayed for use in selected initiating processes.
<positionᵢ>=absolute or relative location on display 20, 906 at which the image data is to be displayed
<projectionᵢ>=parameters, references to parameters, or projected image data to be used in displaying the i^{l}ₕ image on the display 20, 906 in accordance with the image and projection type to be mapped

The number of process images or icons to be displayed can be a function of the desired size(s) and arrangement(s) of the images on the display.

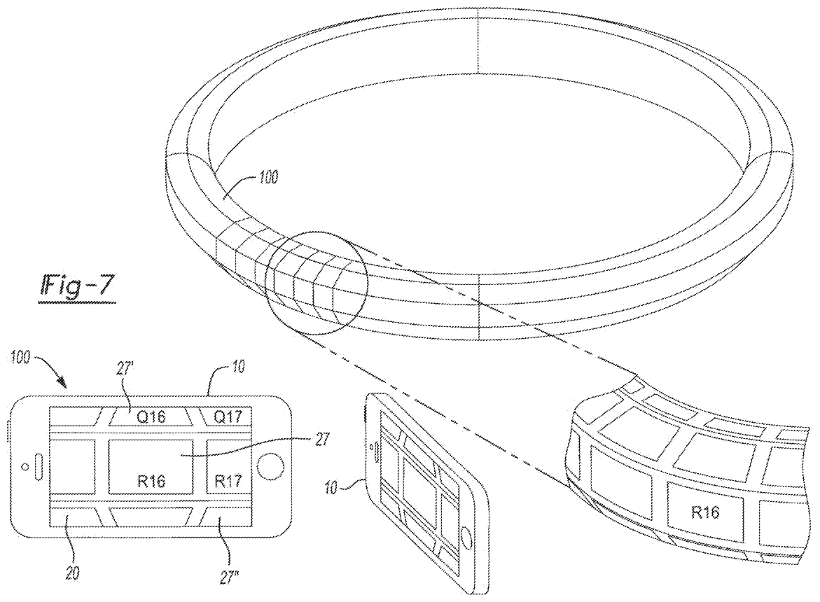

Finally, at 428, the generated initial image display data set can be returned by the application 902 to the processor(s) 900 for display. Accordingly, at 430 the processor(s) can route the initial image data set to the display 20, 906 for display, as shown for example in FIG. 7. For example, at 428 the processor(s) 900 can cause the initial image display data set to a display register, buffer, or cache 906a, as shown in FIG. 3.

For speed and efficiency in processing, in various embodiments of the invention one or more secondary image display data sets can be generated in accordance with logical rules of application 902, and routed to one or more caches or other physically or virtually distinct short-term memory stores 906a, 906b, 906c associated with the display 906 (see FIG. 3). For example, at 432a, 432b, 432c, etc., secondary image display data sets comprising data records of the type described above in association with the initial image display data sets, pertaining to all or any part of process icons 27, 27′, 27″, etc., in the rows and/or columns adjacent to the icons currently displayed can be routed to one the caches 906b, 906c, etc., for rapid repainting of display touchscreen 20 as the user 90 uses the touchscreen to navigate the 2-D process array 100.

At 434, using any suitable known or after-developed touchscreen navigation technologies, a user 90 can scroll left and right through the table 100 to review and choose one or more of the image items 27 by dragging a finger or virtual pointer in either direction across the screen along the X-X axis. Doing so can cause columns to be “dropped” off one end of the displayed image portion, while a corresponding number of new columns can be added to the other, so that a continually-changing set of icons is presented for consideration by the user.

Similarly, ‘rolling’ of the wheel or cylinder about the L-L axis by dragging one's finger up or down along the screen 20 can cause new rows to ‘appear’ at the top of the wheel, and other rows to ‘disappear behind the ‘bottom’ of the wheel, if the user scrolls up and down on the screen. This can cause a continually changing set of game icons to appear.

As will be understood by those skilled in the relevant arts, the terms ‘up’, ‘down,’ ‘left,’ and ‘right’ are relative terms. In this disclosure they are typically used in association with the screen orientation(s) shown and their relative orientation with respect to a user or viewer 90. As will be understood from the disclosure above, up-down/left-right operations are largely similar in terms of image and display processing.

For example, at 434 in FIG. 4 a user 90 wishing to scroll in any direction along either the R or L axes of a virtual toroid, for example as shown in FIG. 8, can drag his or her finger, or other pointer, along the surface of a touchscreen 20 in a desired direction. Doing so can cause a corresponding navigation command signal to be generated at 436, by the touchscreen 20 and/or driver 906 and routed to processor(s) 900 for interpretation and corresponding processing. As will be understood by those skilled in the relevant arts, using for example known touchscreen processes, the meaning of the command input at 434 can be determined by the strength and duration of a user's contact, and by the rapidity with which, for example, the point of contact is moved across the screen. Using for example known techniques, such parameters can be used to generate a new display screen, which can for example be defined by setting a new set of coordinates in the virtual mapping to serve as a ‘centerpoint’ for the display to be generated, and centered on corresponding screen centerpoint 37.

Any suitable touchscreen or other GUI scrolling techniques can be used, including for example swiping of a finger to initiate motion, use of finger-swiping rate to determine scrolling speed, ‘inertial’ effects of the wheel, etc. When a user has scrolled in any direction far enough to exhaust the listing of games, the controller can return to the top of the listing and start again, for example through the use of image ‘wrapping’ techniques as shown in Figures conceptually in 6 and 7.

At 438-440, the processor(s) 900 can apply logic associated with the application 900 to the virtual coordinates corresponding to the new centerpoint 37 as generated at 436, and generate a refreshed image display data set comprising new data similar to that used to generate the initial image display data set. Notably, if suitably secondary image display data sets have been generated at for example 432a-432c, etc, and stored in caches 906a-906c, etc, then at 442 a suitably configured cached image display command can be routed by the processor(s) 900 to the display 906, which can rapidly read and display corresponding cached data by writing it to a suitable display register.

When the user 90 has used processes 434-442 to navigate to a portion of the virtual display 100 which displays a desired process image 27, at 446 the user can initiate or otherwise invoke the corresponding process by selecting the image 27 by for example tapping the touch screen, using a control device such as command buttons 110, 904 to generate a suitably configured process initiation command to be generated by the processor(s) 900 and at 450, 452-454 routed to either or both of process application 902 and process host or server 940, and thereby cause the host or server to start the game or other process, and to receive further input commands from the controller 10, 111 and provide corresponding data to the processor(s) via the communication system 908.

For example, when a desired game has been seen on the display, the user 90 can tap the screen at the location of the corresponding icon 27 to select the game, and thereby cause the users app and/or the gaming server to switch to a corresponding gaming state, with generation and display of GUIs adapted for the game.

Thus, in various aspects and embodiments the invention provides multi-process interface controllers 10, 111, such a controller comprising at least one data processor 900, at least one touchscreen input/output device 906, 20, 904 and at least one network communication system 910, wherein the at least one data processor 900 is configured to generate, in accordance with command signals received from the at least one input device 20, 906, 904 and logical rules associated with a multi-process access control application 102, 902 of the multi-process interface controller 10, 111, a list processes request command data set. The processor(s) 900 can further be configured to, using the at least one network communication system 908, route the list processes request command data set to a multi-process host system 970; receive from the same or another multi-process host system 970, via the same or another network communication system 908 and in response to the list processes request command data set, an available process list data set comprising data representing a listing of games or other processes; in accordance with logical rules associated with the same or another control application 102, 902, generate display command signals useful for generating and displaying a graphical representation of at least a portion of a two-dimensional table or matrix 100 of a plurality of identifiers associated with at least a portion of data processes associated with identifiers comprised by the available process list data set; in response to a scroll navigation command signal received from a same or other input device 20, 904, 906, generate display command signals useful for generating and displaying a graphical representation of at least a different portion of the two-dimensional table or matrix 100, comprising identifiers associated at least party with a different portion of data processes associated with identifiers comprised by the available process list data set, the at least partly different portion of data processes corresponding to data processes associated with different values according to at least a first of the two dimensions. If the display signal command generated in response to the scroll navigation command includes at least one of a minimum or a maximum value associated with least the first of the two dimensions, the processor can include, among the identifiers associated with the different portion of data processes at least one identifier associated with a maximum or minimum value, respectively, of the first dimension. In response to a second navigation command signal received from a same or other input device 20, 904, 906, the at least one data processor 900 generate display command signals useful for generating and displaying a graphical representation of at least another different portion of the two-dimensional table or matrix 100, comprising identifiers associated at least party another different portion of data processes associated with identifiers comprised by the available process list data set, the at least partly different portion of data processes corresponding to data processes associated with different values according to at least a second of the two dimensions; and if the second display signal command generated in response to the scroll navigation command includes at least one of a minimum or a maximum value associated with least the second of the two dimensions, include in the identifiers associated with the other different portion of data processes at least one identifier associated with a maximum or minimum value, respectively, of the second dimension.

In further aspects and embodiments, the invention provides both volatile and persistent machine-interpretable media comprising data representing instructions for causing processor(s) 900 and other components of controller(s) 10, 111 to implement any and all of the described processes.

While the disclosure has been provided and illustrated in connection with specific, presently-preferred embodiments, many variations and modifications may be made without departing from the spirit and scope of the invention(s) disclosed herein. The disclosure and invention(s) are therefore not to be limited to the exact components or details of methodology or construction set forth above. Except to the extent necessary or inherent in the processes themselves, no particular order to steps or stages of methods or processes described in this disclosure, including the Figures, is intended or implied. In many cases the order of process steps may be varied without changing the purpose, effect, or import of the methods described. The scope of the invention is to be defined solely by the appended claims, giving due consideration to the doctrine of equivalents and related doctrines.

What is claimed is:

1. A multi-process interface controller, comprising:
at least one data processor;
at least one touchscreen input/output device; and
at least one network communication system;
wherein the at least one data processor is configured to:
in accordance with command signals received from the at least one input device and logical rules associated with a multi-process access control application of the multi-process interface controller, generate a list processes request command data set;
using the at least one network communication system, route the list processes request command data set to a multi-process host system;
receive from the same or another multi-process host system, via the same or another network communication system and in response to the list processes request command data set, an available process list data set comprising data representing a listing of games or other processes;
in accordance with logical rules associated with the same or another control application, generate display command signals useful for generating and displaying a graphical representation of at least a portion of a two-dimensional table or matrix of a plurality of identifiers associated with at least a portion of data processes associated with identifiers comprised by the available process list data set;
in response to a scroll navigation command signal received from a same or other input device, generate display command signals useful for generating and displaying a graphical representation of at least a different portion of the two-dimensional table or matrix, comprising identifiers associated at least party with a different portion of data processes associated with identifiers comprised by the available process list data set, the at least partly different portion of data processes corresponding to data processes associated with different values according to at least a first of the two dimensions;
if the display signal command generated in response to the scroll navigation command includes at least one of a minimum or a maximum value associated with least the first of the two dimensions, including in the identifiers associated with the different portion of data processes at least one identifier associated with a maximum or minimum value, respectively, of the first dimension;
in response to a second navigation command signal received from a same or other input device, generate display command signals useful for generating and displaying a graphical representation of at least another different portion of the two-dimensional table or matrix, comprising identifiers associated at least party another different portion of data processes associated with identifiers comprised by the available process list data set, the at least partly different portion of data processes corresponding to data processes associated with different values according to at least a second of the two dimensions; and
if the second display signal command generated in response to the scroll navigation command includes at least one of a minimum or a maximum value associated with least the second of the two dimensions, including in the identifiers associated with the other different portion of data processes at least one identifier associated with a maximum or minimum value, respectively, of the second dimension.

2. The multi-process interface controller of claim 1, wherein the at least one data processor is configured to, in response to a command signal received from the same or another input device, initiate a data process identified by the command signal.

3. The multi-process interface controller of claim 1, wherein the at least one data processor is configured to generate at least one secondary image display data set comprising references to a plurality of data processes associated with at least one row and at least one column adjacent to a displayed portion of a two-dimensional table of data processes, and store the at least one secondary image display data set in cache memory associated with the at least one display.

4. Persistent machine-interpretable media comprising data representing instructions for causing at least one processor of a multi-process interface controller to:
in accordance with command signals received from at at least one input device of the multi-process interface controller and logical rules associated with a multi-process access control application of the multi-process interface controller, generate a list processes request command data set;
using at least one network communication system of the multi-process interface controller, route the list processes request command data set to a multi-process host system;
receive from the same or another multi-process host system, via the same or another network communication system and in response to the list processes request command data set, an available process list data set comprising data representing a listing of games or other processes;
in accordance with logical rules associated with the same or another control application, generate display command signals useful for generating and displaying a graphical representation of at least a portion of a two-dimensional table or matrix of a plurality of identifiers associated with at least a portion of data processes associated with identifiers comprised by the available process list data set;
in response to a scroll navigation command signal received from a same or other input device, generate display command signals useful for generating and displaying a graphical representation of at least a different portion of the two-dimensional table or matrix, comprising identifiers associated at least party with a different portion of data processes associated with identifiers comprised by the available process list data set, the at least partly different portion of data processes corresponding to data processes associated with different values according to at least a first of the two dimensions;
if the display signal command generated in response to the scroll navigation command includes at least one of a minimum or a maximum value associated with least the first of the two dimensions, including in the identifiers associated with the different portion of data processes at least one identifier associated with a maximum or minimum value, respectively, of the first dimension;
in response to a second navigation command signal received from a same or other input device, generate display command signals useful for generating and displaying a graphical representation of at least another different portion of the two-dimensional table or matrix, comprising identifiers associated at least party another different portion of data processes associated with identifiers comprised by the available process list data set, the at least partly different portion of data processes corresponding to data processes associated with different values according to at least a second of the two dimensions; and
if the second display signal command generated in response to the scroll navigation command includes at least one of a minimum or a maximum value associated with least the second of the two dimensions, including in the identifiers associated with the other different portion of data processes at least one identifier associated with a maximum or minimum value, respectively, of the second dimension.

5. The persistent machine-interpretable media of claim 4, configured to cause the at least one data processor to, in response to a command signal received from the same or another input device, initiate a data process identified by the command signal.

6. The persistent machine-interpretable media of claim 4, configured to cause the at least one data processor to generate at least one secondary image display data set comprising references to a plurality of data processes associated with at least one row and at least one column adjacent to a displayed portion of a two-dimensional table of data processes, and store the at least one secondary image display data set in cache memory associated with the at least one display.
